(19) United States
(12) Patent Application Publication
(10) Pub. No.: US 2002/0134682 A1
(43) Pub. Date: Sep. 26, 2002

(54) Device for balanced high speed submarine gel electrophoresis

(76) Inventor: Stephen L. Chen, Beaverton, OR (US)

Correspondence Address: Stephen L. Chen, 18510 SW Honeywood Dr., Beaverton, OR, 97006, US

(21) Appl. No.: 09/816,964

(22) Filed: Mar. 23, 2001

(51) Int. Cl. G01N 27/26; G01N 27/447

(52) U.S. Cl. 204/621; 204/616

(57) ABSTRACT

A device is provided for balanced high speed submarine gel electrophoresis. In the device, a conductive balancing liquid is introduced over gel matrix to generate heat, a thicken cooler bottom slows down heat absorption, which results in quick temperature elevation to 33° C. The elevated temperature around 33° C. is utilized to accelerate gel speed and to minimize vertical temperature gradient of the gel matrix.

### FIELD OF THE INVENTION

The present invention is generally related to devices for gel electrophoresis and is particularly directed to apparatuses used for high speed submarine gel electrophoresis.

### BACKGROUND OF THE INVENTION

Gel electrophoresis is one of the most commonly utilized tools in biomedical researches and industries. In gel electrophoresis, a group of samples is applied into a row of sample wells of a gel matrix. Buffer liquid immerses the gel matrix and conducts electric current from a pair of electrodes to the gel matrix. Sample components migrate from sample wells into the body of gel matrix under the action of the electric field. Different components migrate differently so that they can be separated from each other in electrophoresis. Their migration rates are mostly controlled by the voltage of the electric field applied. Higher voltages result in higher migration rates under a given condition. One typical phenomena associated with electrophoresis is that heat is always generated due to electric resistant. Higher voltage generates more heat.

Submarine gel electrophoresis is, due to its simplicity in operation, one of the most popular formats used for DNA analysis. The gel matrix is horizontally placed on a gel bed and immersed completely in buffer. Buffer conducts electric current from one electrode to another electrode via both the gel matrix and the buffer over the gel matrix. A massive heat can be generated, which causes quick rise of temperature during electrophoresis. The gel matrix can, unfortunately, be melt at rising temperature. These features limit submarine gel electrophoresis as a slow process, which is known as conventional submarine gel electrophoresis. Devices used for low speed submarine gel electrophoresis are defined as conventional submarine gel apparatus.

Conventional submarine gel electrophoresis fails to meet the demand of booming development of modern biotechnology. Fast working pace and potent capacity of massive sample examination are essential requirements for laboratories. Attempts have been made to accelerate the speed of the submarine gel electrophoresis.

While in pursuing high speed, temperature distribution in gel matrix, a minor factor in conventional low speed gel electrophoresis, becomes a major limiting difficulty in high speed gel designs.

Temperature is one of the factors in determining sample migration rate. A group of identical molecules in applied sample should migrate together to form a sharp band. But they will migrate differently if they are located into differential temperature zones in the gel matrix, which results in loss of sample resolution.

Hoefer et al, U.S. Pat. No. Des. 282,352, teaches a device for high speed submarine gel electrophoresis. An organic coolant is enclosed in its base under gel matrix. Hoefer fails to recognize the importance of even temperature distribution. First, he fails to control vertical temperature balance. Heated buffer has a tendency of moving upwards but his coolant is placed at bottom, which results in an uneven vertical temperature distribution in gel matrix. The temperature in upper region of its gel matrix is higher than that in lower region, which leads to loss of sample resolution. Secondly, Hoefer fails to control horizontal temperature balance across different sample wells, which causes loss of banding straightness across sample lanes. Thirdly, his coolant is permanently sealed inside chamber base. The whole device needs to be frozen prior to high speed submarine gel electrophoresis.

Chen, U.S. Pat. No. 5,549,806, teaches a device for high speed submarine gel electrophoresis. Chen recognizes the importance of horizontal temperature balance but fails to reach vertical temperature balance. His cooling water generates no heat but absorbs heat instantly from gel top surface, which generates a serious vertical temperature gradient from top region of gel matrix to bottom region. This vertical temperature gradient in gel matrix will cause unacceptable sample resolution loss if used at higher voltages, which limits Chen's device to be useful only with a moderate voltage range.

A device for high speed submarine gel electrophoresis with temperature balance features is highly desirable but remains unsolved.

### SUMMARY OF THE INVENTION

It is, therefore, an object of the present invention to further investigate temperature effects so that a device for high speed submarine gel electrophoresis with temperature balance features can be successfully provided. The advantages of the present invention are:

1. It enhances sample resolution substantially. A balancing liquid is introduced between gel matrix and coolant. Balancing liquid generates heat at user adjustable level to minimize vertical temperature gradient in gel matrix.

2. It reaches further higher speed. Temperature is utilized to accelerate sample migration rate, rather than using higher voltage alone in seeking high speed.

3. It ensures banding straightness by placing its cooler over its gel matrix.

### BRIEF DESCRIPTION OF THE DRAWINGS

FIG. 1a and 1b are illustrative diagrams showing the effects of horizontal temperature distribution on sample banding straightness.

FIGS. 2a to 2f are illustrative diagrams showing the effects of vertical temperature distribution on sample resolution.

FIGS. 3a to 3d are perspective views of a presently preferred embodiment of the invention.

FIGS. 4a to 4c are sectional views showing a setup operation of the embodiment.

### DETAILED DESCRIPTION OF THE INVENTION

Temperature, as a major difficulty in high speed gel electrophoresis, has been deeply investigated during the generation of the invention. FIG. 1a and 1b illustrate the effects of horizontal temperature distribution on sample banding straightness. Under ideal condition, Bands 6 across all sample lanes should migrate at identical speeds so that bands 6 from all sample wells 2 can form straight banding pattern, as shown in FIG. 1a. But in reality, banding straightness is always a challenge to device designers. Most frequent seen banding pattern is shown in FIG. 1b, known as “band smiling”. Uneven horizontal temperature distribution is one of the major factors leads to band smiling. It does not result in loss of sample resolution. Vertical uneven temperature distribution is the cause of sample resolution loss in high speed gel electrophoresis.

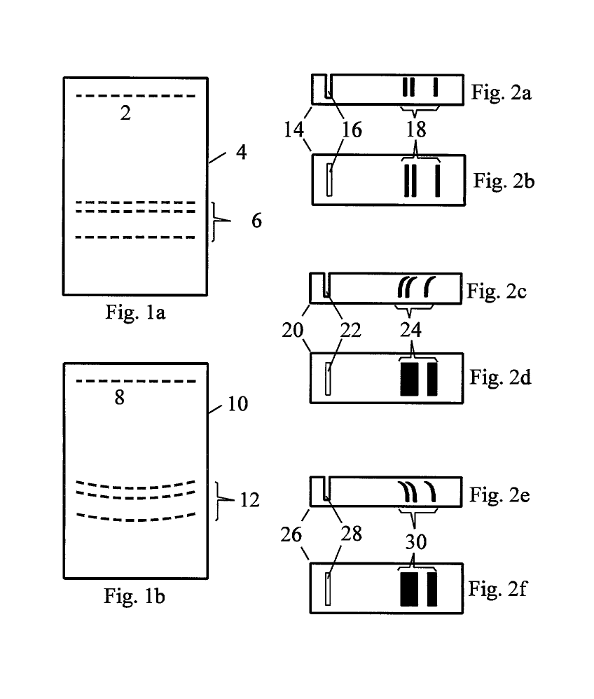

Under ideal condition, identical molecules should migrate at identical speed to form vertical bands. FIG. 2a is a diagram of a gel piece 14 viewed from side. Sample migrates from well 16 to form bands 18 in sharp lines. Bands 18 are still sharply distinguishable in photographic picture even though bands 18 are viewed from top of gel piece 14, as shown in FIG. 2b.

When temperature in top region of gel piece 20 is higher than temperature at lower region, like the condition of Hoefer device, molecules at top migrate faster than molecules at bottom, forming tilted bands 24. Bands 24 are still distinguishable from side view, as shown in FIG. 2c. But gel photographic pictures are always taken from top view instead of side view. The sample resolution is then lost due to the overlap of titled bands, as shown in FIG. 2d. FIGS. 2e and 2f show another condition of uneven vertical temperature distribution, like the condition seen in Chen's device. The temperature at top region of gel piece 26 is lower than the temperature at bottom region so that molecules at top migrate slower. In both cases, sample resolution has been lost.

The success of reaching high speed and high sample resolution in the invention is based on two novel concepts:

1. Using a balancing liquid to minimize temperature gradient.

2. Generating heat to accelerate high speed further, rather than cooling down gel matrix.

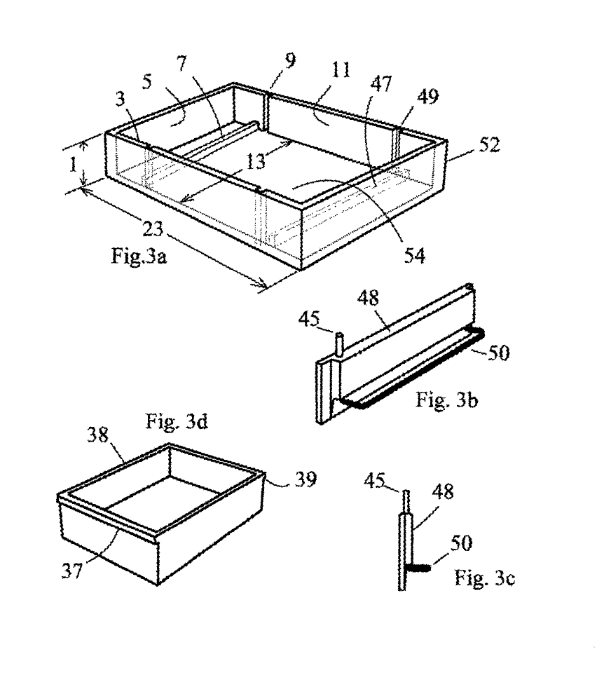

FIGS. 3a to 3d show a presently preferred embodiment of the invention.

Base 52 is made with clear acrylic material, having an open top and a UV transparent bottom 54 in rectangular shape surrounded by two end walls and two longitudinal walls. For general applications, base height 1 is designed to 3.5 cm and base length 23 is 20 cm. Base width 13 has no required relationship with its height 1 so that it can be altered widely to satisfy different applications. On bottom 54, two dams, 7 and 47, are glued in parallel to each other for defining a rectangular gel when pouring gel solution into middle region of bottom 54. Two slots, 9 and 49, are built on longitudinal wall 11 for engagement of detachable piece 48 during system setup for electrophoresis. Another two slots are built on longitudinal wall 3 in the same way as slots 9 and 49. These slots determine the locations and parallel directions of detachable pieces.

Detachable piece 48, seen as perspective view in FIG. 3b and end view in FIG. 3c, can be inserted into and removed from slot 49 smoothly. Another detachable piece, identical to detachable piece 48, is used to insert into slot 9 in the same way. To simplify base structure, electrode 50 and connector 45 are associated with detachable piece 48, which is only a minor design feature irrelevant to the achievement of the invention. For durability concerns, detachable piece 48 is made with white PVC material. Detachable piece 48 can be built into different configurations as long as it can engage with longitudinal wall 3, longitudinal wall 11, and gel matrix 46 with its edges to minimize buffer inflow over gel matrix.

A cooler 38 is used to hold coolant for absorbing heat. Cooler 38 is made with clear plastic in rectangular shape, having thicken bottom wall about 3 mm. Two stepped shoulders, 37 and 39, support cooler 38 against longitudinal wall 3 and longitudinal wall 11 so that the bottom of cooler 38 is evenly lift up from base bottom 54. The volume capacity of cooler 38 is about 250 ml.

A setup of the device is as follows:

1. Pour gel solution directly onto bottom 54 to form gel matrix 46 in rectangular shape between dam 7 and dam 47. Sample well 41 is formed near dam 7.

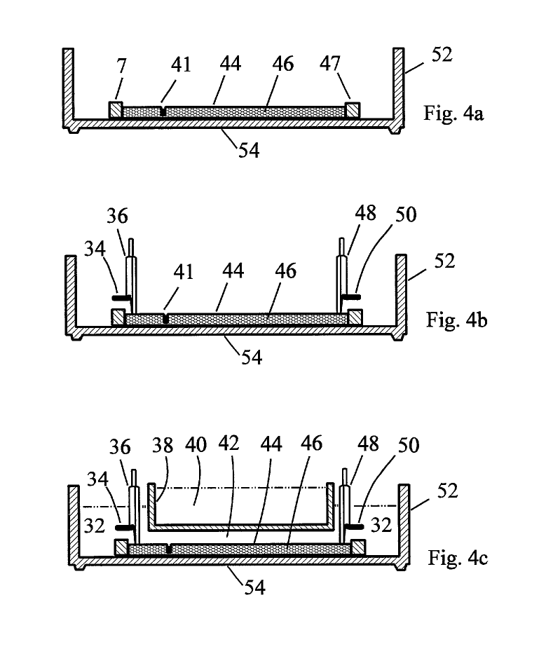

2. Insert a pair of detachable pieces, 36 and 48, into slots, 9 and 49, all way down until their firm engagement with gel matrix 46. Two detachable pieces are parallel with each other and located adjacent to each gel end, as shown in FIG. 4b. Their insertion establishes a balancing compartment over gel matrix 46.

3. Add a balancing liquid 42 into balancing compartment over gel matrix 46, add buffer 32 into base 52 at each end, load samples, and then place cooler 38 against longitudinal walls of base 52. The bottom of cooler 38 contacts balancing liquid for reliable thermal communication. Ice 40 is included in cooler 38 as coolant for heat absorption.

4. Conduct electric current from an external power supply to the device via electrodes, connectors, and wires to cause sample migration and temperature elevation.

The working principle of the device is as follows:

Studies of the invention shown that sample migration can be substantially accelerated under a safe temperature around 33° C. When using a constant voltage, the speed of electrophoresis can be almost doubled at 33° C., in comprising to a temperature below 10° C. Within this safe temperature range, gel matrix 46 maintains its solid condition and its resolving capacity very well so that 33° C. can be utilized to accelerate gel speed. The challenge is then to find an easy way for reaching 33° C. quickly at beginning and then postponing its further increase after 33° C.

Balancing liquid 42, a novel concept in high speed submarine gel electrophoresis, is first introduced by the invention. Balancing liquid 42, containing conductive ions at a user adjustable concentration, generates heat to help temperature elevation during the initiation period of electrophoresis so that sample migration rate can be speed up quickly in a short time. Temperature elevation in balancing liquid 42 also minimizes uneven vertical temperature gradient in gel matrix 46 so that high sample resolution can be maintained.

A 3-mm bottom of cooler 38 is specially designed in the embodiment. It slows down heat absorption when balancing liquid 42 is cold at initiation period of electrophoresis because the temperature difference between two sides of the bottom is not significant. But its heat transfer efficiency is then significantly enhanced when balancing liquid 42 has been warmed up to higher temperature, such as 33° C., because the temperature difference is greater now.

The best ion concentration of balancing liquid 42 is determined by different applications. It can be prepared easily by dilution of buffer 32. For instance, in a 6-minute application, it can be adjusted to 30% of the ion concentration of gel matrix 46, for a 30-minute application, it can be controlled to 10% of the ion concentration of gel matrix 46. But it should not excess over 50% of the ion concentration of gel matrix 46 because cooler 38 as designed in this embodiment is not powerful enough to maintain safe temperature.

By using balancing liquid 42 at elevated temperature on gel matrix 46, higher sample resolution and higher sample migration rate can be achieved simultaneously. A routine mini-gel application can be completed in less than 10 minutes at 250 V with results of straight bands and high sample resolution.

The use of detachable pieces, 36 and 48, allows gel removal easier. There may be, depending on user, a minor liquid communication between buffer 32 and balancing liquid 42. But its effects are usually not detectable from gel results. Alternatively, detachable pieces can be inserted into slots prior to pouring gel solution so that liquid communication can be further minimized.

To ensure even horizontal temperature distribution, cooler 38 is placed above gel matrix 46 and cooler bottom should contact balancing liquid 42 completely. The distance between cooler bottom and gel top surface 44 is about 5 mm.

Although the description above contains specifications, it will apparent to whose skilled in the art that a number of other variations and modifications may be made in this invention without departing from its spirit and scope. Slots 9 and 49, for example, can be omitted, dam 7 and 47 can be omitted, detachable pieces 48 can be glued on to longitudinal wall 11, cooler bottom wall can be 2 mm thickness, cooler 38 can be even omitted and replaced with water circulation tubing, electrode 50 can be constructed with base 52, gel matrix can be formed outside base 52, and additional gel tray can be used for gel transfer. Thus, the description as set out above should not be constructed as limiting the scope of the invention but as merely providing illustration of the presently preferred embodiment of the invention.

What is claimed is:

1. A device for balanced high speed submarine gel electrophoresis, comprising:
a base, made liquid impermeable for holding buffer of electrophoresis, having a bottom in substantially rectangular shape with a base length between two end walls and a base width between two longitudinal walls, being accessible from top;
a gel matrix, on top of said bottom around middle region, in a substantially rectangular shape with a first gel end, a second gel end, and a plurality of sample wells in parallel with said first gel end, being capable of resolving sample mixture into distinguishable bands under action of an external power applied via connections of electrodes, connectors, and wires;
a first piece, being capable of engaging with said two longitudinal walls and said gel matrix at a first location adjacent to said first gel end and in parallel with said first gel end substantially;
a second piece, being capable of engaging with said two longitudinal walls and said gel matrix at a second location adjacent to said second gel end in parallel with said second gel end substantially;
a balancing chamber, defined by said first piece, said second piece, said two longitudinal walls, and said gel matrix, minimizing inflow of said buffer over said gel matrix;
a balancing liquid, held within said balancing chamber on top of said gel matrix, containing conductive ions at user adjustable concentration, conducting electric current to generating heat for temperature elevation and minimizing vertical temperature gradient of said gel matrix;
a cooling structure, having a thermal wall thick enough to slow down heat absorption, contacting said balancing liquid for thermal communication, and
a coolant, held inside said cooling structure and isolated from said balancing liquid, absorbing heat from said balancing liquid and said gel matrix via said thermal wall.

2. The device as claimed in claim 1 wherein said balancing liquid has ion concentration at a level 2 of 30% of the ion concentration of said gel matrix.
